(19) United States
(12) Patent Application Publication
(10) Pub. No.: US 2006/0117818 A1
(43) Pub. Date: Jun. 8, 2006

(54) Vehicle anti-theft device

(76) Inventor: Hsing-Jen Wei, Taipei County (TW)

Correspondence Address: Hsing-Jen Wei, P.O. Box No. 6-57, Junghe, Taipei, 235, TW

(21) Appl. No.: 11/000,967

(22) Filed: Dec. 2, 2004

(51) Int. Cl. E05B 65/19

(52) U.S. Cl. 70/240

(57) ABSTRACT

The present invention is a vehicle anti-theft device including a master controller inside an engine room, a remote controller to control operations of the master controller, and at least a set of locking device to lock a hood on the engine room. By pressing the remote controller, the anti-theft device will be activated to trigger vehicle doors to be locked through a central control lock, a circuit connecting a battery set and the engine room to be cut, and a hood lock to lock the hood on the engine room, thereby protecting the master controller from being destroyed and also enhancing anti-theft capability.

### BACKGROUND OF THE INVENTION

(a) Field of the Invention

The present invention relates to an improvement of a vehicle anti-theft device which is triggered by a master controller to activate a central control lock to lock doors, to disconnect a circuit between a battery set and an engine, and to lock a hood of a vehicle, thereby protecting the master controller from being destroyed and enhancing anti-theft capability.

(b) Description of the Prior Art

A conventional vehicle anti-theft device can simply be a mechanic lock and also can be a central control lock plus a siren.

While a conventional anti-theft device, powered by a battery inside an engine room, is limited to locking doors and while only a mechanic lock formed to secure a hood on the engine room, the anti-theft device can be easily voided by cutting power supply after damaging the mechanic lock thereof.

### SUMMARY OF THE INVENTION

The present invention is an improvement of a vehicle anti-theft device including a remote controller, a master controller inside an engine room, and at least a set of locking device securing a hood on the engine room. By pressing buttons of the remote controller, the anti-theft device thereby being activated, which further triggers a central control lock to lock vehicle doors, a circuit connecting a battery set and the engine room to be cut, and a hood lock to lock the hood on the engine room, thereby protecting the master controller from being destroyed and also enhancing anti-theft capability.

In addition, the hood lock of the anti-theft device is extra to an inherent hood lock and can be installed when installing the anti-theft device, the hood lock thereby providing an extra securing mechanism for the hood on the engine room.

Certainly, the hood lock can be standard equipment installed during vehicle production phase. The master controller can be an optional, which can be installed later simply by connecting circuits between the hood lock and the master controller thereof.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention.

FIG. 2 shows an exploded elevational view of a hood lock structure of the present invention.

FIG. 3 shows a prospective view of the present invention with a locking angle bar of the hood lock inserting into a groove.

FIG. 4 shows a prospective view of the present invention with the locking angle bar and a locking pin in a locking position.

FIG. 5 shows a prospective view of the present invention with an angle pry bar in action.

### DETAILED DESCRIPTION OF THE PREFERRED EMBODIMENTS

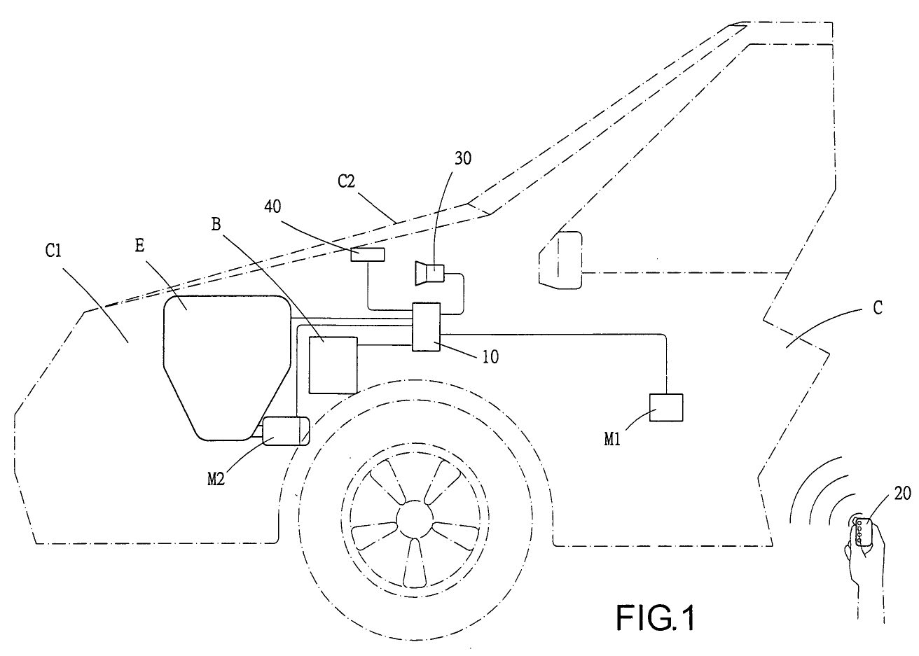

Referring to FIG. 1. The present invention of a vehicle anti-theft device includes a master controller 10 formed inside an engine room C1 of a vehicle C, having a circuit connecting a battery set B and an engine E and another circuit connecting the battery set B and a starter M2, wherein a control circuit and a wireless receiving module, both powered by the battery set B, formed to receive signals to control connectivity of the engine E, the starter M2, and a siren 30, and movements of a central control lock motor M1 and a hood lock 40, as well as, possibly, front/rear lights.

A remote controller 20 includes buttons, a battery set, a control circuit and a wireless transmitting module to transmit signal to control actions of the master controller 10. An inner code set burned over each control circuit of the remote controller 20 and the master controller 10. Upon pressing buttons of the remote controller 20 to activate the master controller 10, the inner code set will be transmitted thereto for identification prior to activating.

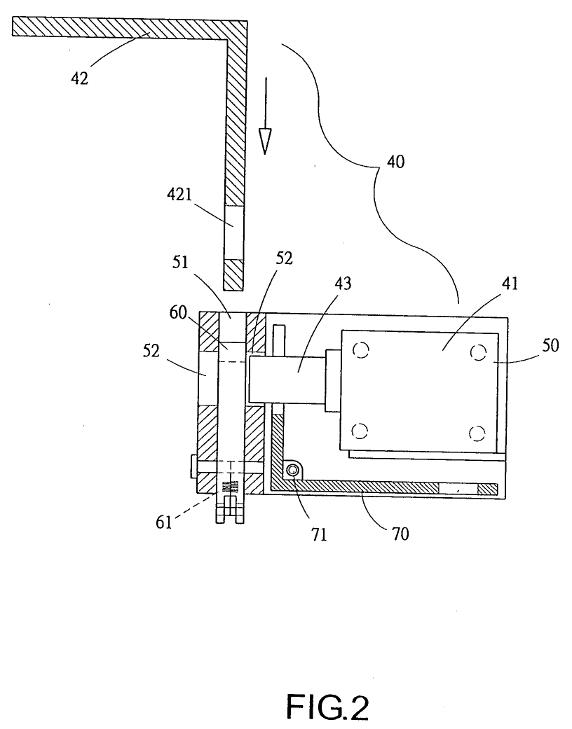

At least a hood lock 40, being extra to an inherent hood lock, formed between the engine room C1 and a hood C2, to be controlled by the master controller 10 to lock the hood C2 thereon. Referring to FIG. 2. The hood lock 40 includes a drive unit 41 formed in the engine room C1 and a locking angle bar 42 formed on the hood C2, wherein the drive unit 41, being an electromagnetic valve and controlled by the master controller 10, driving a lock pin 43 moving in and out a locking hole 421 formed on the locking angle bar 42.

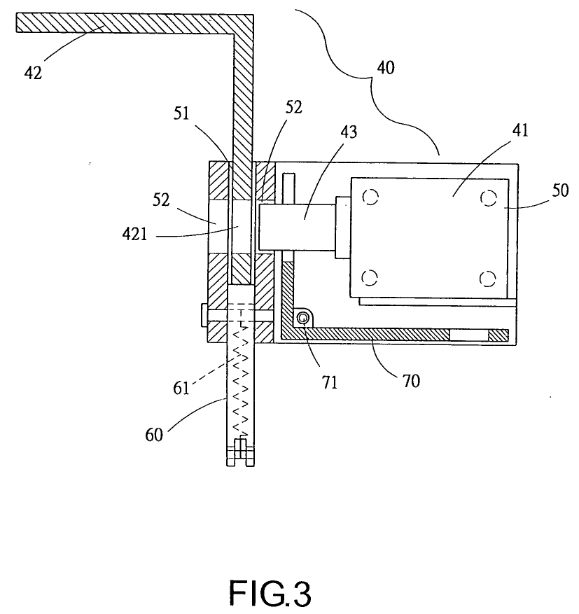

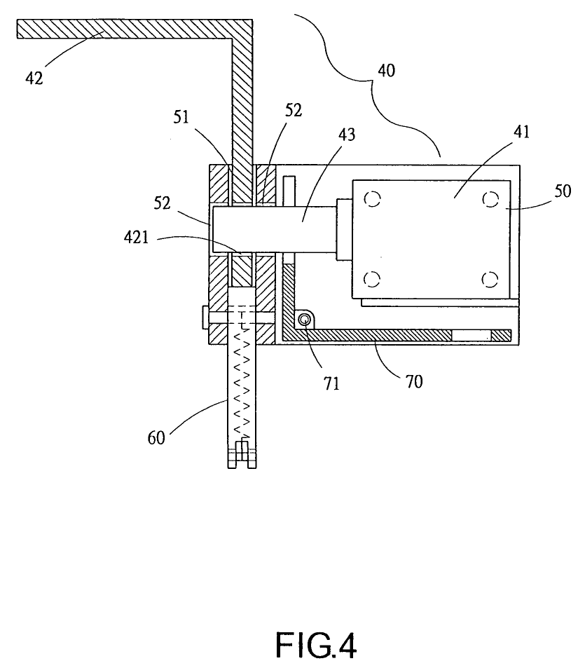

Referring to FIGS. 3 and 4. The drive unit 41 formed on a base 50, wherein a groove 51 formed on the side of the lock pin 43 of the drive unit 41 to accommodate the locking angle bar 42, and openings 52 corresponding to the locking hole 421 formed on both sides of the groove 51, thereby enabling the lock pin 43 penetrating through openings 52 of the base 50 and the locking hole 421 of the locking angle bar 42 to secure the hood C2 on the engine room C1.

Referring to FIG. 1. By pressing buttons of the remote controller 20, the master controller 10 will be activated to trigger the central control lock motor M1 locking the vehicle C through the central control lock, to disconnect the circuit from the battery set B to the engine E and the starter M2, and to lock the hood C2 on the engine room C1 through the hood lock 40. In addition, the hood lock 40 is an extra lock, which can be formed stealthy in the engine room C1 when installing the anti-theft device, thereby preventing the hood lock 40 from being discovered and also protecting the master controller 10 and circuits thereof from being destroyed, besides an advantage of enhancing locking stability between the hood C2 and the engine room C1. Certainly, the hood lock 40 can be standard equipment installed during the vehicle production. The master controller 10 can be an optional, to be installed later simply by connecting a circuit between the hood lock 40 and the master controller 10.

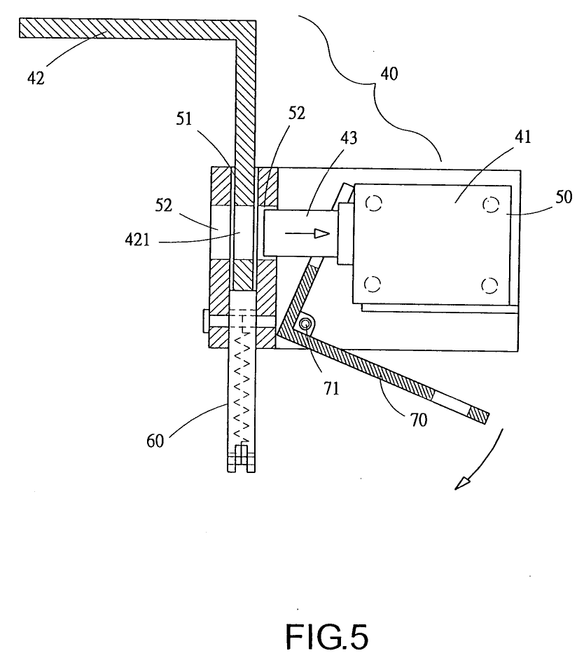

Referring to FIGS. 2 and 3. A buffer 60, being in the form of a sliding block, formed in the groove 51 of the base 50, wherein an elastic element 61, being in the form of a spring, formed between the buffer 60 and the bock 50 to absorb a downward impact of the locking angle bar 42 when closing the hood C2. An angle pry bar 70 formed on the base 50, wherein a side extending to the locking pin 43 and a hinge pin 71 hinging the angle portion thereof at the base 50. Referring to FIG. 5. Manually opening the hood C2 can be done by rotating the angle pry bar 70 to force the locking pin 43 moving opposite to the locking hole 421, in case the locking pin 43 cannot be actuated, when performing maintenance works.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A vehicle anti-theft device comprising:
a master controller inside an engine room, having a circuit connecting a battery set and an engine, wherein a control circuit and a wireless receiving module, both powered by the battery set, formed to receive signals to control connectivity of the engine and a siren, as well as movements of a central control lock motor and a hood lock;
a remote controller, comprising buttons, a battery set, a control circuit and a wireless transmitting module, to be used to transmit signal to control actions of the master controller;
at least a hood lock formed between a hood and the engine room to lock the hood thereon, when being activated by the master controller.

2. The vehicle anti-theft device as recited in claim 1, wherein an inner code set burned over each control circuit of the remote controller and the master controller such that a set of inner code signal, when pressing buttons, will be transmitting from the remote controller to the master controller for identification prior to activating the master controller.

3. The vehicle anti-theft device as recited in claim 1, wherein the hood lock comprising a drive unit formed in the engine room and a locking angle bar formed on the hood, to be controlled by the master controller to drive a lock pin moving in and out a locking hole in the locking angle bar, thereby enabling the hood locking on the engine room, when the hood covering on the engine room and the locking pin moving in the locking hole.

4. The vehicle anti-theft device as recited in claim 3, wherein the drive unit formed on a base, with a groove to accommodate the locking angle bar formed on the side of the lock pin of the drive unit and openings corresponding to the locking hole formed on both sides of the groove of the base, thereby enabling the lock pin penetrating through openings of the base and the locking hole of the locking angle bar to secure the hood on the engine room.

5. The vehicle anti-theft device as recited in claim 4, wherein a buffer formed in the groove of the base to absorb a downward impact of the locking angle bar.

6. The vehicle anti-theft device as recited in claim 5, wherein the buffer, being a sliding block, formed in the groove and an elastic element formed between the buffer and the base.

7. The vehicle anti-theft device as recited in claim 4, wherein an angle pry bar formed on the base, with a side extending to the locking pin and with a hinge pin hinging the angle portion at the base such that manually opening the hood can be done by rotating the angle pry bar to force the locking pin moving opposite to the locking hole, in case the locking pin cannot be actuated.

8. The vehicle anti-theft device as recited in claim 1, wherein the master controller having a circuit connecting the battery set and a starter to control connectivity of the starter.

9. The vehicle anti-theft device as recited in claim 6, wherein the elastic element is a spring.

10. The vehicle anti-theft device as recited in claim 3, wherein the drive unit is an electromagnetic valve.
